(19) United States
(12) Patent Application Publication
(10) Pub. No.: US 2005/0076211 A1
(43) Pub. Date: Apr. 7, 2005

(54) Method for protecting computer programs against unauthorized multiple use

(75) Inventors: Pavol Bobonko, Michalovce (SK); Elisabeth Zukrigl, Wien (AT)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/913,283

(22) Filed: Aug. 9, 2004

Related U.S. Application Data
(60) Provisional application No. 60/492,978, filed on Aug. 7, 2003.

(30) Foreign Application Priority Data
Jun. 8, 2003 (DE) 10336083.2

(51) Int. Cl. H04L 9/00

(52) U.S. Cl. 713/165

(57) ABSTRACT

The invention relates to a method for protecting interpreted computer programs against unauthorized multiple use, whereby the computer programs are encrypted by means of cryptographic methods, characterized in that an essential part of the cryptographic methods required for the encryption of computer programs is executed as a component of the interpreter program. The invention is particularly significant for programs which have been designed in the Java programming language, providing said programs with an effective protection against unauthorized multiple use.

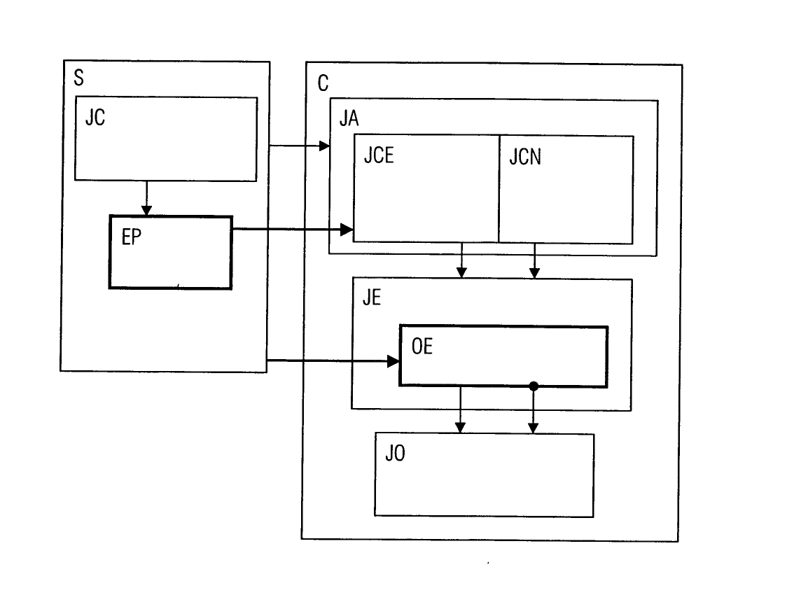

The invention relates to a method for protecting interpreted computer programs against unauthorized multiple use, whereby the computer programs are encrypted by means of cryptographic methods.

The encryption of computer programs (software) is a conventional approach in terms of protecting against unauthorized use. One weak point of the known methods is the fact that in addition to the encrypted software, the key required for decoding must also be provided in a suitable form. This is not deemed a problem for programs which are supplied in the form of a machine code, in other words a binary numerical sequence understood immediately by a computer as a command sequence, since in this case the analysis of the program and thus the identification of the key cannot be implemented with an economically justifiable outlay.

The delivery of the key can however cause problems in programs which are executed by means of a so-called interpreter, wherein the program is not translated from the programming language or if necessary from a generated intermediate code step by step into the executable machine code until it is run on a target computer, and the translated command is executed even before the next command is translated.

In these cases the key must be transferred in the programming language which is easily readable by a person skilled in the art or in a similarly easily readable intermediate code, it then being possible to find the key out in a comparatively simple manner and to bypass encryption.

The object of the invention is therefore to improve encryption with interpreted computer programs and hence to increase protection against unauthorized use.

This object is achieved according to the invention by means of a method of the type mentioned in the beginning, whereby an essential part of the cryptographic methods required for encrypting computer programs is executed as a component of the interpreter program.

Integration into the interpreter, which is advantageously created in the C++ programming language, compiled in machine code and delivered in this form, makes it much more difficult to find these program parts out, in line with conventional security requirements.

The method can be particularly advantageously used in interpretable computer programs which are executed in the Java programming language. Java is a programming language which has been developed particularly for use in networked systems and has thus gained particular significance for Internet applications.

Symmetrical methods such as the so-called ‘Blowfish’ method can be used advantageously as encryption methods. Block ciphers are particularly suitable, whereby the encoding and decoding of the data is effected block by block, in 64-bit blocks for instance.

The encryption of security-relevant program parts alone is often sufficient to protect the program. The interpretation of the program can thus be accelerated.

The invention is described in more detail with reference to an exemplary embodiment illustrated schematically in the FIGURE.

The exemplary sketch shows a Java program protected in accordance with the invention.

This is typically one of the following two types of program:

Applications which are complete Java programs containing all components relevant to their execution, classes in particular, and

Applets, which are smaller applications requiring specific classes of software in the case of the client or target computer on which they should operate.

Java was developed specifically for use in resources distributed in computer networks and in the corresponding network nodes. Java is thus particularly suited to client/server systems and in particular to applications operating on the clients. However, this field of application makes effective protection against unauthorized use of these programs particularly important.

According to the invention a specific application, i.e. a JAVA program is created by a software manufacturer S and is converted into a platform-neutral byte code or P-Code JC by means of a compiler. For a person skilled in the art this code is just as easy to analyze as the Java source code. The complete program or at least its security-relevant components are thus converted into encrypted form by means of cryptographic methods EP in order to prevent unauthorized use.

The encrypted or unencrypted byte code is routed to the customer and/or transmitted to the computer system JA operated by said customer. It is stored there as encrypted byte code JCE or unencrypted byte code JCN. With Internet applications, the application can also be loaded onto a client JA via the network.

Computer system or client JA contain the interpreter JE, which converts the byte code into machine code JO. With Internet applications, the interpreter JE is usually contained in the WWW browser of the client JA. According to the invention, this interpreter JE now also contains the cryptographic algorithms OE necessary for decoding the encrypted program parts, i.e. with a symmetrical method like the Blowfish method, in particular the key with a length of 32 to 448 bits. Other encryption methods such as the Diffie-Hellman method for example can be used as an alternative to the said method.

It is essential that the software manufacturer delivers not only the application itself to the customer, but also a relevant interpreter JE containing the encryption algorithms OE.

The interpreter software JE in the form of a directly executable machine code is transferred to the customer C and/or the computer system in contrast to the JAVA application which must be transmitted as interpretable software, as easily readable byte code, as a result of its characteristics. Thus under practical conditions it is virtually impossible to find out the key required for decoding.

One advantage of the preferred symmetrical cryptographic methods used is the comparatively rapid operational sequence of the algorithms used, so that no significant delay of the interpreter process occurs due to encoding.

The Blowfish method belongs to the class of the so-called block ciphers, wherein the encryption algorithm is applied to data blocks of constant length in each case, in the present case with a length of 64 bits. These block ciphers are thus particularly suited to decoding the JAVA program commands in the course of the step-by-step execution of the program by the interpreter.

1. A method for protecting interpreted computer programs against unauthorized multiple use, wherein the computer programs are encrypted by means of cryptographic methods, comprising
executing a part of the cryptographic methods required for decrypting computer programs as a component of the interpreter program.

2. The method according to claim 1, wherein
the interpreted computer program is executed in Java programming language.

3. The method according to claim 1, wherein
a symmetrical method is used as an encryption method, wherein a same key is used for encrypting and decrypting data.

4. The method according to claim 3, wherein
a block cipher method is used as an encryption method, wherein the encryption operation is applied to 64-bit blocks.

5. The method according to claim 1, wherein
the Blowfish method is used as an encryption method.

6. The method according to claim 1, wherein
one part of the computer programs to be protected is encrypted.

7. The method according to claim 1, wherein the interpreter program is executed in C++ programming language and transferred in compiled form as a machine code.
